(19) United States
(12) Patent Application Publication
(10) Pub. No.: US 2019/0047756 A1
(43) Pub. Date: Feb. 14, 2019

(54) DISINFECTING MULTI-DOSAGE VIAL CAP

(71) Applicant: ENGAGE BIOTECH, INC, Everett, WA (US)

(72) Inventors: Katherine Brandenstein, Woodinville, WA (US); Emily Willard, Everett, WA (US)

(21) Appl. No.: 16/075,055

(22) PCT Filed: Jan. 26, 2017
(86) PCT No.: PCT/US17/15140

§ 371 Date: Aug. 2, 2018

Related U.S. Application Data
(60) Provisional application No. 62/302,821, filed on Mar. 3, 2016.

(51) Int. Cl. B65D 51/00; A61J 1/14; A61J 1/06; A61J 1/20

(52) U.S. Cl. CPC B65D 51/002; A61J 1/1406; A61J 1/065; A61J 1/1487; A61J 1/1443; A61J 1/2096; A61J 1/1425

(57) ABSTRACT

A disinfecting cap and method of manufacturing may include a first section and a second section. The first section may include a first plate, a container, a first seal, a second seal, and a sanitizing agent. The second section may include a sleeve mount. The container may include a second plate, a lateral wall, and an inner chamber, the inner chamber and the lateral wall being positioned between the first plate and the second plate, with the second section being adjacent to the second plate and opposite the first plate and the first needle port and the second needle port being collinearly aligned to the sleeve mount.

### CROSS-REFERENCE TO RELATED APPLICATIONS

This application claims priority to and benefit of provisional application No. 62/302,821, filed Mar. 2, 2016, and which is incorporated herein by reference in its entirety.

### BACKGROUND

Each year more than 16 billion injections are given worldwide, and it is estimated that seven billion of these injections are given with contaminated equipment. Unsafe injections, as a result of contaminated needles and syringes, were responsible for 21 million Hepatitis B, 2 million Hepatitis C, and 210,000 HIV infections in 2000 according to the World Health Organization. Contaminations are a result of a variety of factors. First, developing countries receive a majority of their medical aid from donations. Syringes and needles donated can be expired or previously opened from a cancelled medical procedure. In the case of cancelled medical procedures, previously sterile equipment is opened but unused. Sterility of the equipment cannot be guaranteed as the package has already been opened. Second, there is limited knowledge of sterile procedure in these countries. The same syringe and needle will be reused to give injections to multiple patients. Even a single reuse of a needle results in irreversible contamination of the medication. Medications in multi-dose vials typically contain an antimicrobial preservative that protects from bacterial contamination. This does not, however, protect against viral and other contaminants.

Developing areas such as Africa, Eastern Mediterranean, Europe, and Southeast Asia are the most commonly affected by transmission of pathogens through needle reuse. Needle reuse, however, is a problem even in developed countries such as the United States. In 2015, the New Jersey Department of Health issued a warning that a nurse had given influenza vaccines with reused syringes, and patients who received injections could be at high risk of Hepatitis B, Hepatitis C, and HIV. As such there is a need to reduce the risk of cross contamination from from reusing needles in limited resource environments.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of a disinfecting cap 100.

FIG. 2 illustrates an embodiment of a disinfecting cap manufacturing process 200.

FIG. 3 illustrates an embodiment of a disinfecting cap manufacturing process 300.

FIG. 4 illustrates an embodiment of a disinfecting cap manufacturing process 400.

FIG. 5 illustrates an embodiment of a second section 402.

FIG. 6 illustrates an embodiment of a disinfecting cap manufacturing process 600.

FIG. 7 illustrates an embodiment of a sanitizing agent manufacturing process 700.

FIG. 8 illustrates an embodiment of a disinfecting cap manufacturing process 800 in a sectional view.

FIG. 9 illustrates an embodiment of a disinfecting cap manufacturing process 900 displaying a sectional view of the disinfecting cap.

FIG. 10 illustrates an embodiment of a disinfecting cap 1000 displayed in a sectional view being mounted to a multi-dosage injection vial 116.

FIG. 11 illustrates an embodiment of a disinfecting cap 1100 displayed in a sectional view mounted to a multi-dosage injection vial 116.

FIG. 12 illustrates an embodiment of a disinfecting cap 1200.

FIG. 13 illustrates an embodiment of a disinfecting cap 1300 mounted to a multi-dosage injection vial 116 displayed in a sectional view.

### DETAILED DESCRIPTION

In an embodiment, a disinfecting cap may include a first section and a second section. The first section may include a first plate, a container, a first seal, a second seal, and a sanitizing agent. The second section may include a sleeve mount. The container may include a second plate, a lateral wall, and an inner chamber. The first plate and the second plate comprise a first needle port and a second needle port, respectively. The lateral wall being peripherally positioned around the inner chamber. The inner chamber and the lateral wall being positioned between the first plate and the second plate. The second section being adjacent to the second plate and opposite the first plate. The first needle port and the second needle port being collinearly aligned to the sleeve mount. The first seal being occusively positioned against the first needle port within the container. The second seal being occusively positioned against the second needle port within the sleeve mount. The sanitizing agent being retained within the inner chamber between the first seal and the second seal.

In an embodiment, the second section may include a plurality of ribs, radially positioned within the sleeve mount adjacent to the second plate. The plurality of ribs operate as retainers that engage the exterior of a multi-dosage injection vial, securing the disinfecting cap in place.

In an embodiment, the second section may include at least one wedge-hook fastener perimetrically positioned to the shaft opening. The shaft opening being positioned opposite the second plate across the sleeve mount. The cap of a multi-dosage vial may traverse the shaft opening and the at least one wedge-hook fasteners. The movement of the cap may temporarily displace the position of the at least one wedge hook fasteners, facilitated by the wedge. The sleeve mount may be configured with a depth to the second seal from the shaft opening to fully envelope the cap of the multi-dosage vial, such that the at least one wedge-hook fastener may extend over hook on to the lower portion of the cap.

In an embodiment, the first plate may include a ridge peripherally positioned to the first needle port. The lateral wall may include a recessed channel peripherally positioned to the inner chamber. The ridge on the first plate may operate as a flange to coincidentally engage the recessed channel. The alignment of the ridge to the recessed channel may serve as a structural feature that provides the alignment between the first plate and the container, as well as a gasket to seal the contents of the inner chamber.

A method of manufacturing a disinfecting cap may include forming a first plate in a key cap mold comprising an exterior face, an interior face, a first needle port, and a raised ridge peripherally positioned to the first needle port on the interior face; forming a canister body in a canister base mold comprising an inner chamber, a lateral wall comprising a recessed channel, a second plate comprising a second needle port, and a sleeve mount comprising a plurality of radially positioned ribs; positioning a second seal occlusively over the second needle port opposite the inner chamber; positioning a first seal occlusively over the first needle port on the interior face; filling the inner chamber with a sanitizing agent; mounting the raised ridge to the recessed channel; and hermetically sealing the sanitizing agent in the inner chamber by joining the first plate to the canister body.

In an embodiment, the method of manufacturing the disinfecting cap may include forming the first plate and the canister body from an extruded thermoplastic resin. In some embodiments, the extruded thermoplastic resin may include acrylonitrile butadiene styrene (ABS) plastic resin.

In an embodiment, the first seal and the second seal comprises butyl rubber. The first seal and second seal may operate as a membrane to permitting the passage of a needle through the inner chamber holding the sanitizing agent and into the multi-dosage vial. The butyl rubber provides a compressible self-sealing barrier to prevent contamination and leaking of the sanitizing agent.

In an embodiment, the sanitizing agent may be hermetically sealed the in the inner chamber through the joining of the first plate to the canister body through the utilization of an adhesive or welding technique which may include ultrasonically welding the first plate to the canister body.

The disinfecting cap may be configured as a tamper resistant/tamper evident cap that attaches to the top of a multi-dose vial. A sanitization layer may be built into the interior of the sterilization cap to operate as an antiseptic barrier for allowing safer reuse of needles in areas with limited medical resources. Each time a needle passes through the sanitizing layer, the needle may kill, inhibit or remove pathogens (e.g., bacteria, viruses, pathogenic eukaryotes, etc.,) preventing/reducing contamination of the vial. The sterilization cap may include configurations permitting its attachment to existing configurations of multi-dose vials.

The disinfecting cap may be configured to retrofit existing multi-dosage vial. The disinfecting cap may include a layer in either liquid or gel form for the purpose of sanitizing the needle each time it passes through. The sanitizing layer may include a sanitizing agent. The sanitizing agent may be contained within the cap by two self-sealing membranes that allow the needle to pass through, but prevent the sanitizing agent from leaking into the medication. The disinfecting cap may include a non-removable configuration that prevents removal of the disinfecting cap once attached to a multi-dosage vial.

The disinfecting cap may be manufactured in two parts, a cap and a canister body. The cap may be attached to the canister body which includes a hollow chamber. The hollow chamber may be filled by with a sanitizing agent. The sanitizing agent may be held within the cap by two layers of butyl rubber serving as a self-sealing membrane. One layer may be attached to the bottom portion of the hollow chamber while the other layer may be attached to the cap. The lower portion of the canister body below the hollow chamber may include four snap ribs to provide an interference fit to the top of the vial.

The disinfecting cap may include a liquid or gel layer with antiseptic properties that sanitizes the needle each time it passes through. The liquid or gel layer with antiseptic properties operates as a sanitizing agent. The sanitizing agent may be contained to within the cap by two membranes that allow the needle to pass through, while preventing the sanitizing agent from leaking into the medication. The two membranes may be constructed out of butyl rubber. The sanitizing agent may be accomplished 95% Ethyl Alcohol. Additional configurations for the material of the membrane and the sanitizing agent may be considered. In additional embodiments, the membrane material and sanitizing agent may be changed.

The disinfecting cap may be manufactured using 3D printing techniques where the material construction of the cap and the canister body may be accomplished using acrylonitrile butadiene styrene (ABS) plastic on high density. The disinfecting cap may be configured to fit on the top of ten-milliliter multi-dose vial but may be scaled to fit larger and smaller vials.

The membrane material may be adhered to the interior face of the first plate and to the portion of the second plate facing the sleeve mount. With the second needle port sealed. The container may be filled with the sanitizing agent. The cap may then be lowered onto the canister body aligning it raised ridges with the recessed channel. With the cap engaged to the canister body, a hermetic seal may be formed utilizing a manufacturing method that will prevent the sanitizing agent from leaking out. Possible methods may include, but are not limited to, an adhesive or type of welding including ultrasonic.

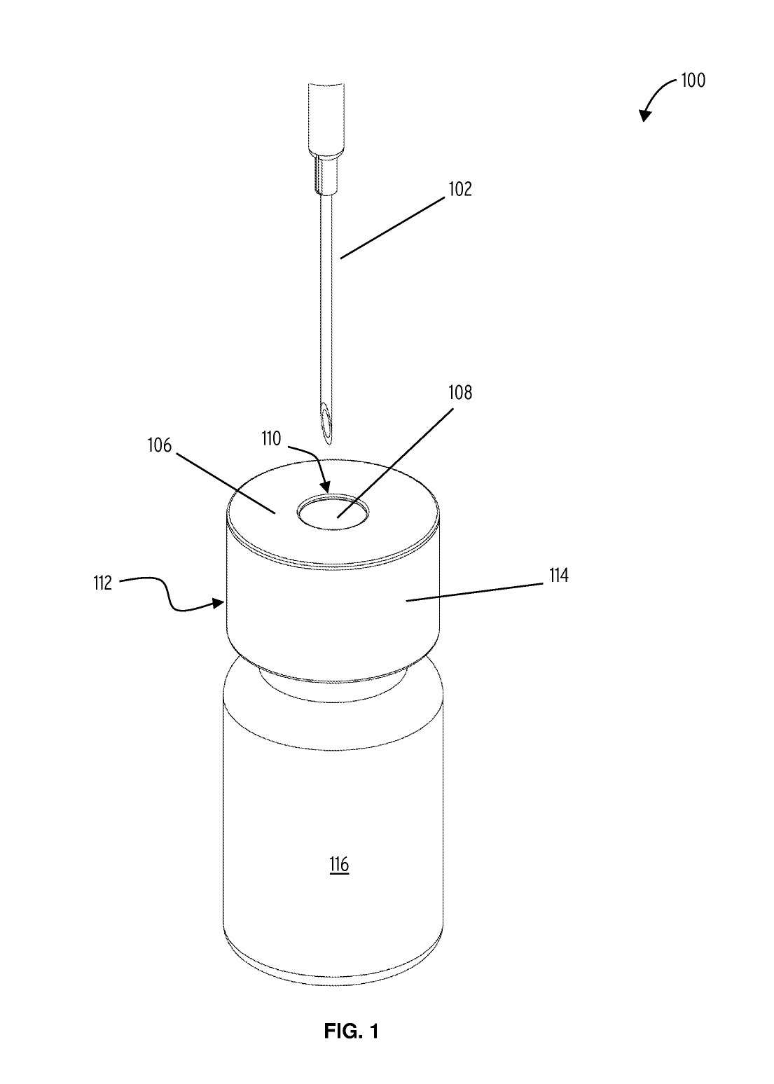

Referencing FIG. 1, the disinfecting cap 100 comprises a first plate 106, a first seal 108, a first needle port 110, a canister body 112, and a lateral wall 114.

The disinfecting cap 100 mounts to a multi-dosage injection vial 116 operating as a sanitizing barrier for a needle 102.

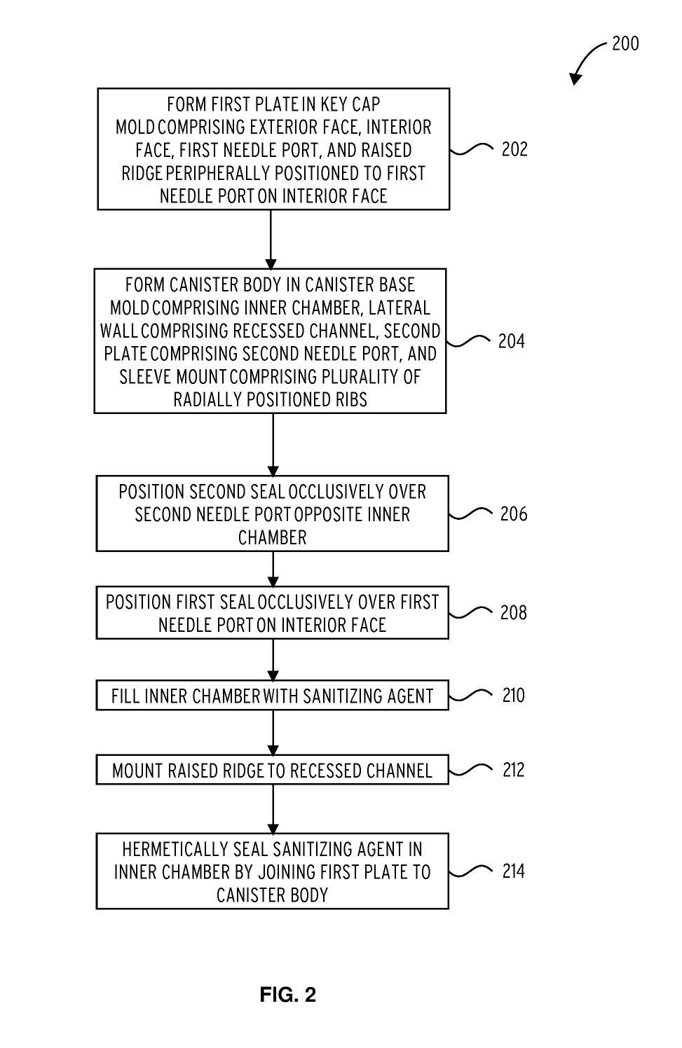

Referencing FIG. 2, a disinfecting cap manufacturing process 200 forms a first plate in a key cap mold comprising an exterior face, an interior face, a first needle port, and a raised ridge peripherally positioned to the first needle port on the interior face (block 202).

The disinfecting cap manufacturing process 200 forms a canister body in a canister base mold comprising an inner chamber, a lateral wall comprising a recessed channel, a second plate comprising a second needle port, and a sleeve mount comprising a plurality of radially positioned ribs (block 204). In an embodiment, the disinfecting cap manufacturing process forms the first plate and the canister body from an extruded thermoplastic resin. Further, in some embodiments the extruded thermoplastic resin may be accomplished by acrylonitrile butadiene styrene (ABS) plastic resin.

Following formation of the first plate and the canister body, the first plate and the canister body are removed from the key cap mold and the canister base mold respectively.

In block 206, the disinfecting cap manufacturing process 200, positions a second seal occlusively over the second needle port opposite the inner chamber. Positioning of the second seal over the second needle port hermetically seals the second needle port. In an embodiment, the second seal may be retained to the second plate utilizing an adhesive and/or structural features of the canister body.

In block 208, the disinfecting cap manufacturing process 200 positions a first seal occlusively over the first needle port on the interior face. Positioning of the first seal over the first needle port hermetically seals the first needle port. In an embodiment, the first seal may be retained to the interior face of the first plate utilizing an adhesive and/or structural features of the first plate and/or canister body.

The disinfecting cap manufacturing process 200, fills the inner chamber with a sanitizing agent (block 210). In an embodiment, the sanitizing agent may be accomplished by antiseptics that include, but are not limited to, formalin, ethyl alcohol, hydrogen peroxide, iodine, and etc. In some embodiments, the inner chamber may receive the sanitizing agent from a filling nozzle. The filling nozzle may adjust the volume of the sanitizing agent delivered relative to the volume of the inner the chamber based on the properties of the selected sanitizing agent (e.g., viscosity, volatility, concentration, etc.,).

In block 212, the disinfecting cap manufacturing process 200 mounts the raised ridge to the recessed channel. The raised ridge of the first plate aligns coincident with the recessed channel of the lateral wall of the canister body. The raised ridge interlocks with the recessed channel interlocking the first plate with the canister body. In some embodiments, the raised ridge and the recessed channel may operate as alignment features for aligning the first needle port with the second needle port.

The disinfecting cap manufacturing process 200 hermetically seals the sanitizing agent in the inner chamber joining the first plate to the canister body (block 214). The hermetic seal formed between the first needle port and the first seal, the second needle port and the second seal, and the first plate with the canister body, seals the sanitizing agent within the inner chamber. In some embodiment the hermetic seal between the first plate and the canister body may be formed through utilization of an ultrasonic welder or compression welder to mechanically join the first plate with the canister body.

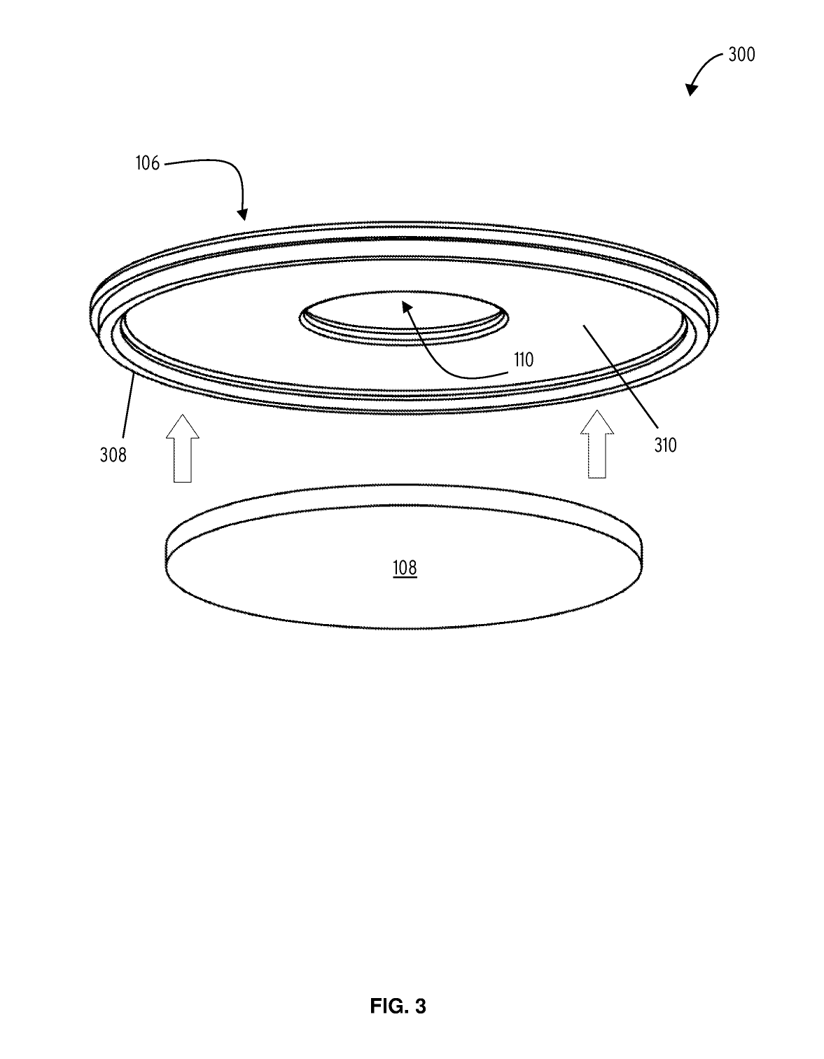

Referencing FIG. 3, the disinfecting cap manufacturing process 300 comprises a first plate 106 being joined to the a first seal 108. The first plate 106 comprises a raised ridge 308, an interior face 310, and a first needle port 110. The first seal 108 is coupled to the interior face 310 of the first plate, occlusively sealing the first needle port 110.

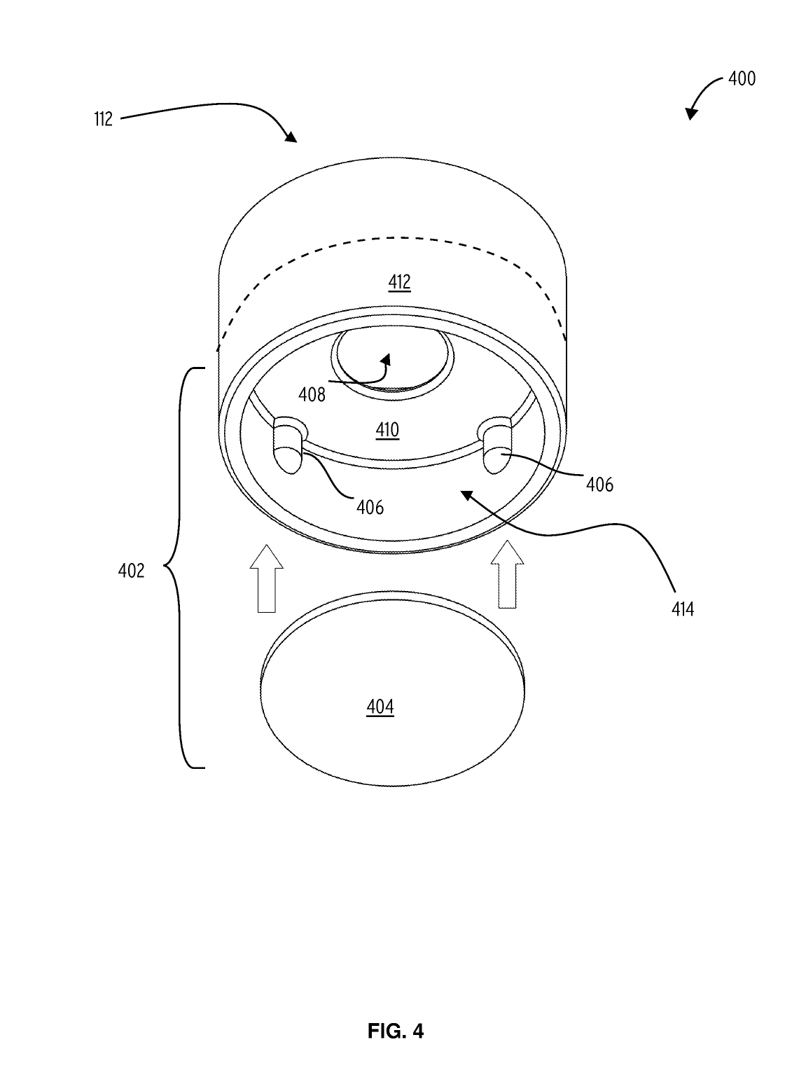

Referencing FIG. 4, the disinfecting cap manufacturing process 400 comprises a second seal 404 being joined to the a canister body 112. The canister body 112 comprises a second section 402 comprising a sleeve mount 412, a shaft opening 414, and a plurality of ribs 406 radially positioned on the interior of the sleeve mount 412. The second plate 410 separates the inner chamber from the second section 402. The second section being adjacent to the second plate and opposite the first plate. The second plate 410 comprises a second needle port 408 centrally traversing the body of the second plate 410. The second seal being occusively positioned against the second needle port within the sleeve mount. The second seal 404 occlusively seals the second needle port 408 when joined to the second plate 410. In some embodiments the plurality of ribs 406 may assist in retaining the second seal 404 to the second plate 410.

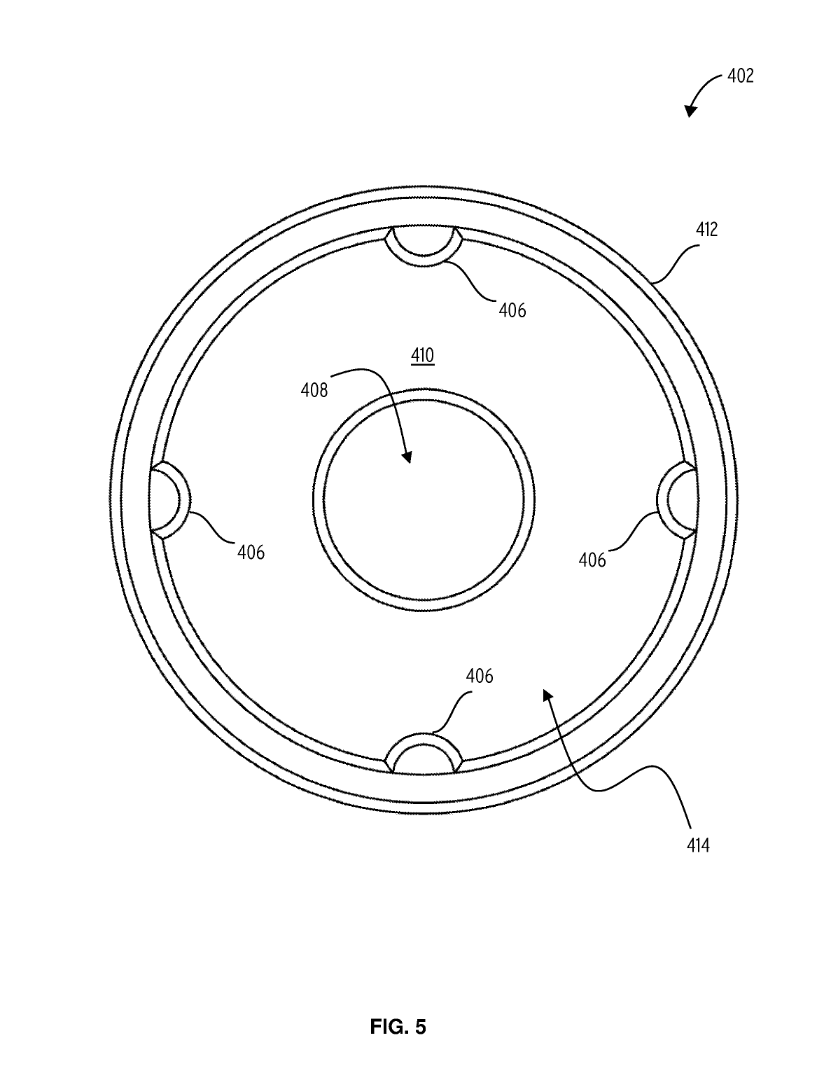

Referencing FIG. 5, the second section 402 comprises a plurality of ribs 406, a second needle port 408, a second plate 410, a sleeve mount 412, and a shaft opening 414. The plurality of ribs 406 being radially positioned to on the interior of the sleeve mount 412 adjacent to the second plate 410.

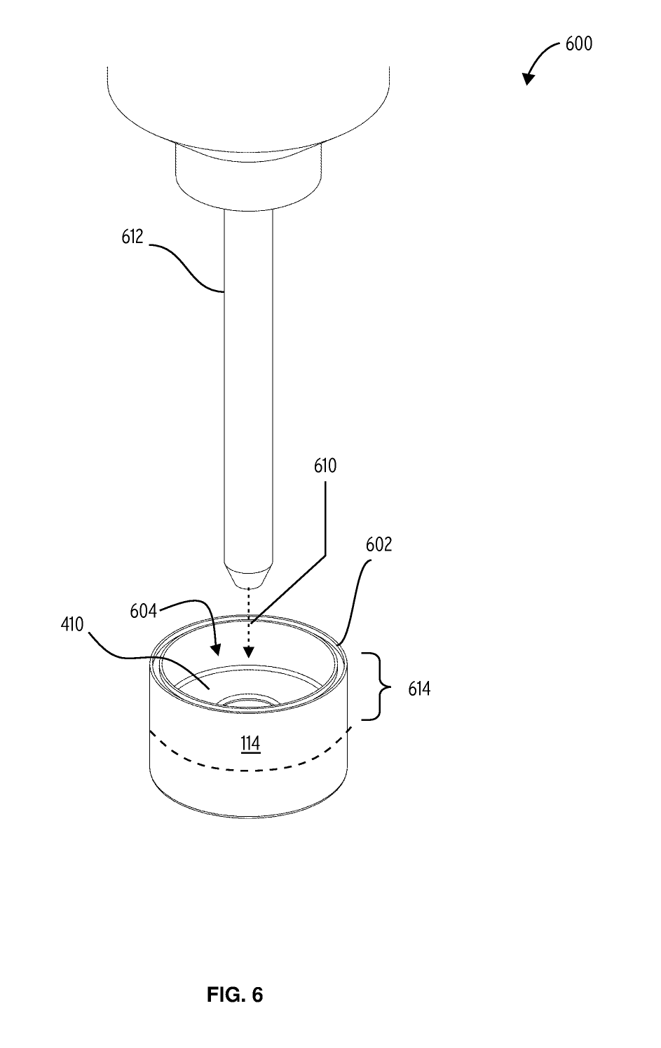

Referencing FIG. 6, the disinfecting cap manufacturing process 600 comprises the process of filling the inner chamber 604 with a sanitizing agent 610. A filling nozzle 612 may be utilized to deliver a measured volume of an antiseptic solution or compound into the container 614. The container 614 comprises a lateral wall 114, a second plate 410, a recessed channel 602, and an inner chamber 604.

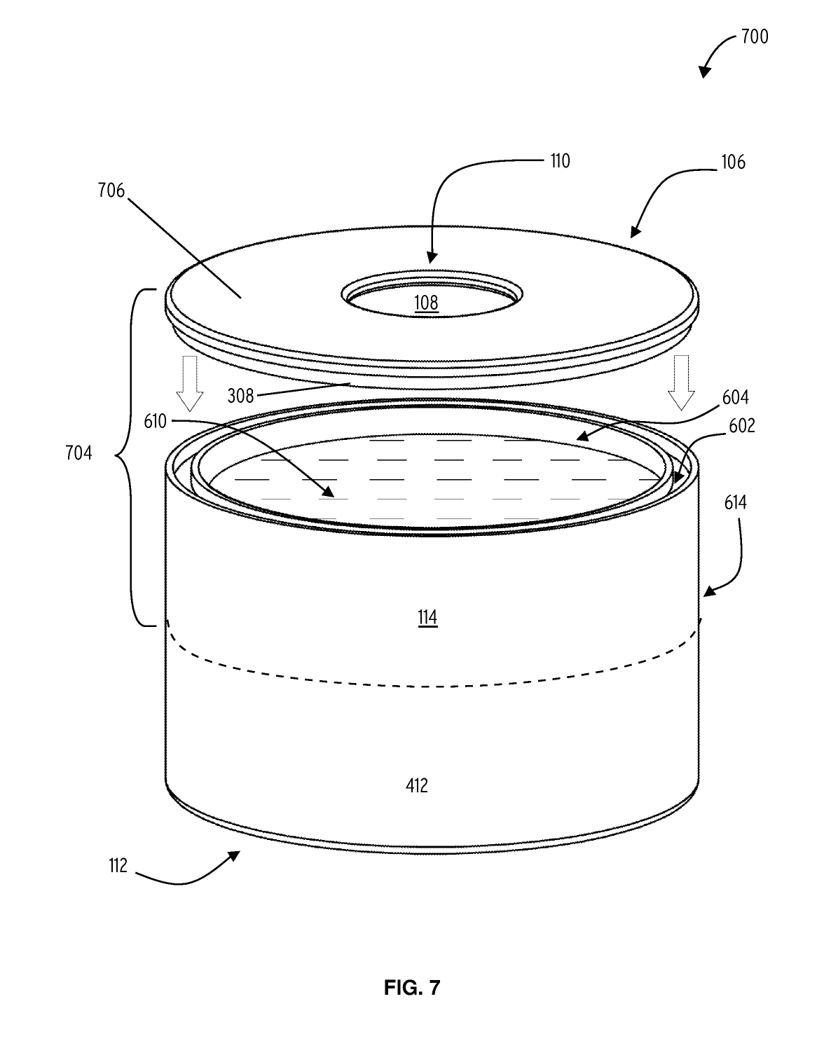

Referencing FIG. 7, the sanitizing agent manufacturing process 700 illustrates the process of attaching the first plate 106 to the canister body 112 after being filled with a sanitizing agent 610. The first plate 106 comprises a first seal 108, a first needle port 110, an exterior face 706, and a raised ridge 308. The canister body 112 comprises a container 614 and a sleeve mount 412. The container 614 being positioned between the sleeve mount 412 and the first plate 106. The container 614 comprises the section of the canister body 112 that joins to the first plate 106. The first plate 106 and the container 614 form a first section 704 of the disinfecting cap. The container 614 comprises a lateral wall 114, a recessed channel 602, a sanitizing agent 610, and an inner chamber 604.

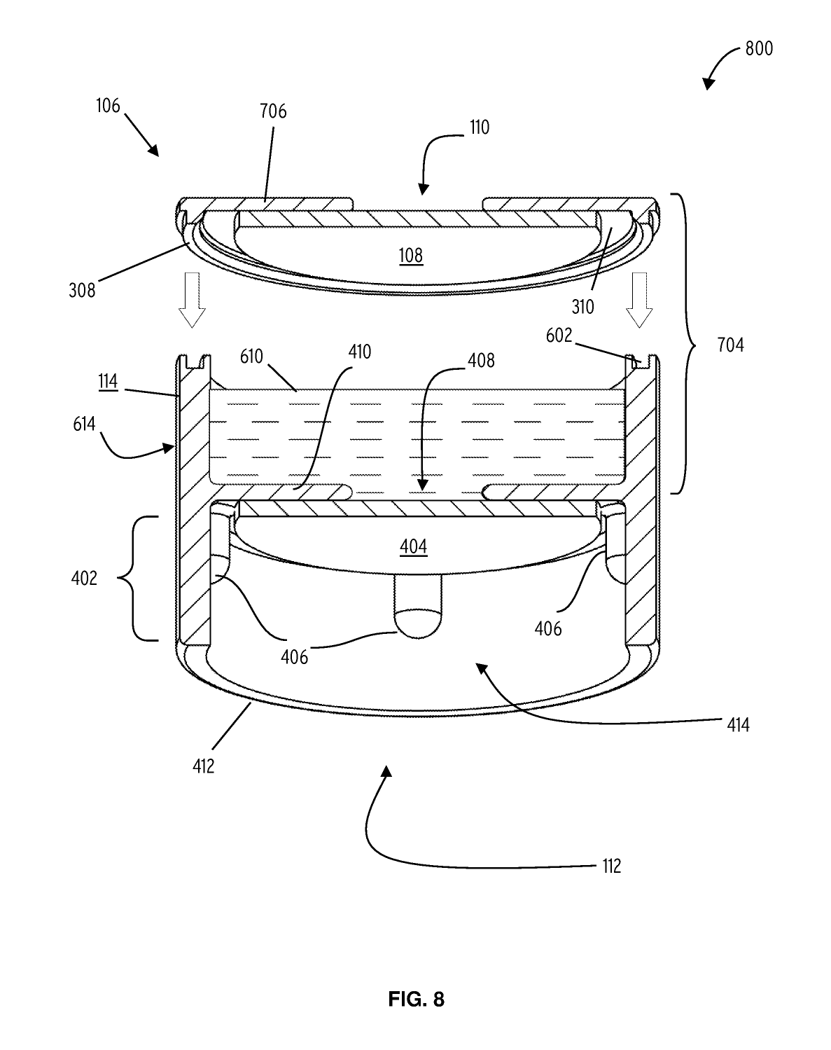

Referencing FIG. 8, the disinfecting cap manufacturing process 800 illustrates a sectional view of the process of mounting the first plate 106 to a container 614 of the canister body 112. The first plate 106 being mounted to the container 614 by the engagement of the raised ridge 308 to the recessed channel 602. The first section 704 comprises the first plate 106, a first seal 108, a container 614, a sanitizing agent 610, and a second seal 404. The first plate 106 comprises an exterior face 706, an interior face 310, a first needle port 110, and a raised ridge 308. The container 614 comprises a lateral wall 114, a second plate 410, and a sanitizing agent 610 within the inner chamber. The sanitizing agent 610 being retained within the inner chamber by the lateral wall 114, the second plate 410, and the second seal 404. The second needle port 408 of the second plate 410 being occlusively sealed by the second seal 404 positioned within the sleeve mount 412. The canister body 112 comprises a second section 402 comprising plurality of ribs 406, a sleeve mount 412, and a shaft opening 414.

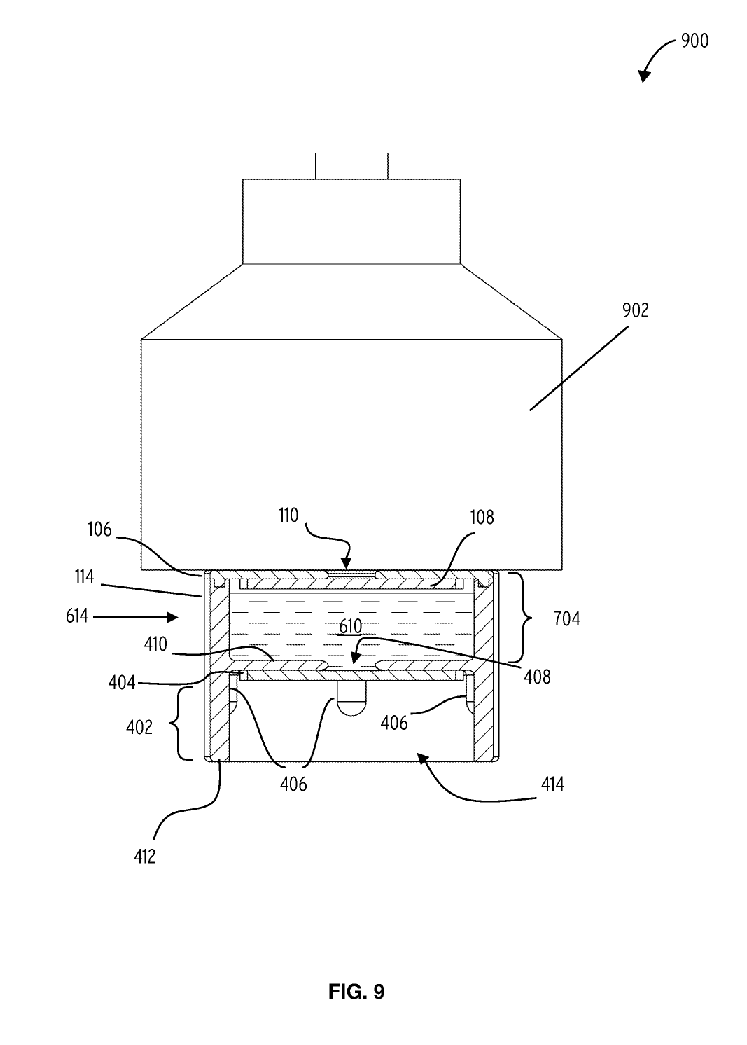

Referencing FIG. 9, the disinfecting cap manufacturing process 900 illustrates a process of sealing the first plate 106 to the container 614 through the utilization of an ultrasonic welder 902. The ultrasonic welder 902 may engage the first plate 106 mounted to the container 614 to form a hermetic seal generating the assembled disinfecting cap. The sterilization cap comprises a first section 704 comprising a first plate 106, a first seal 108, a second seal 404, and the container 614. The first plate 106 comprises a first needle port 110. The container 614 comprises the lateral wall 114, sanitizing agent 610, and the second plate 410 comprising a second needle port 408. The second needle port 408 being occlusively sealed by the second seal 404. The first needle port 110 and the second needle port 408 being collinearly aligned to the sleeve mount 412. A second section 402 being positioned opposite the ultrasonic welder 902 across the first section 704. The second section 402 comprises the sleeve mount 412, a shaft opening 414, and a plurality of ribs 406.

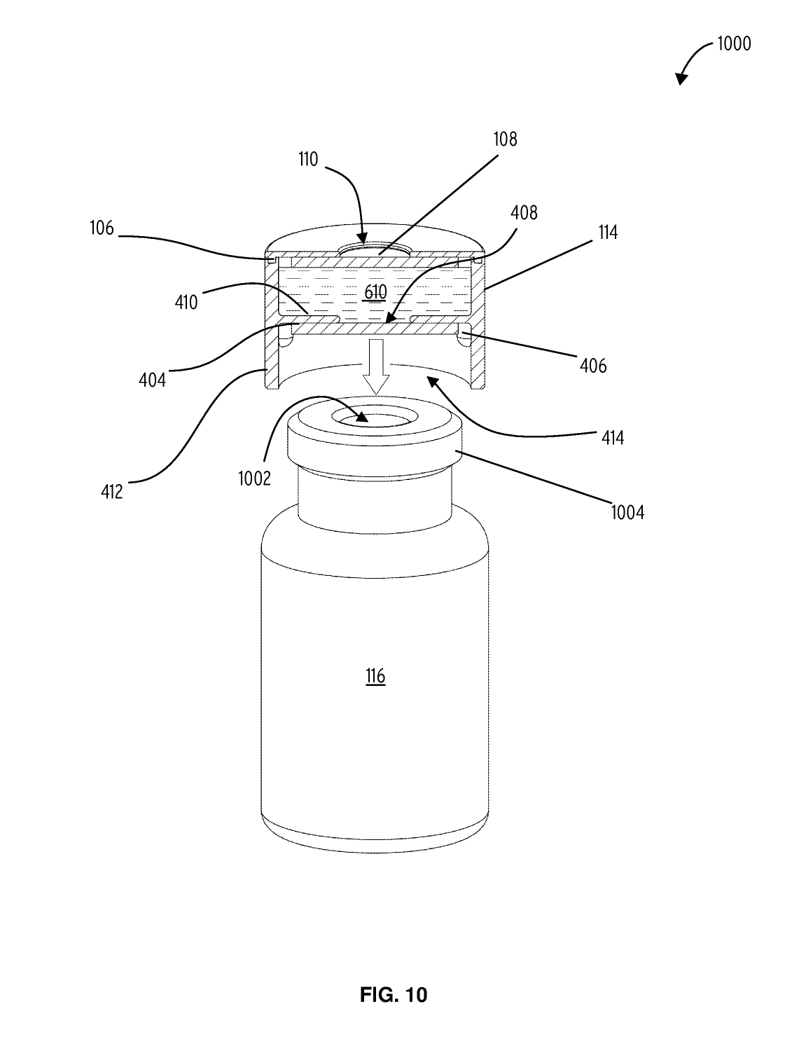

Referencing FIG. 10, the disinfecting cap 1000 comprising the first plate 106, the lateral wall 114, the second plate 410, the first seal 108, the second seal 404, the sanitizing agent 610, the sleeve mount 412, a shaft opening 414, and the plurality of ribs 406 being lowered into position onto a multi-dosage injection vial 116. The multi-dosage injection vial 116 comprises a needle port 1002 centrally positioned on a cap 1004. The sleeve mount 412 sleeves the cap 1004 aligning the needle port 1002 with the first needle port 110, the sanitizing agent 610, and the second needle port 408. The plurality of ribs 406 engage the cap 1004.

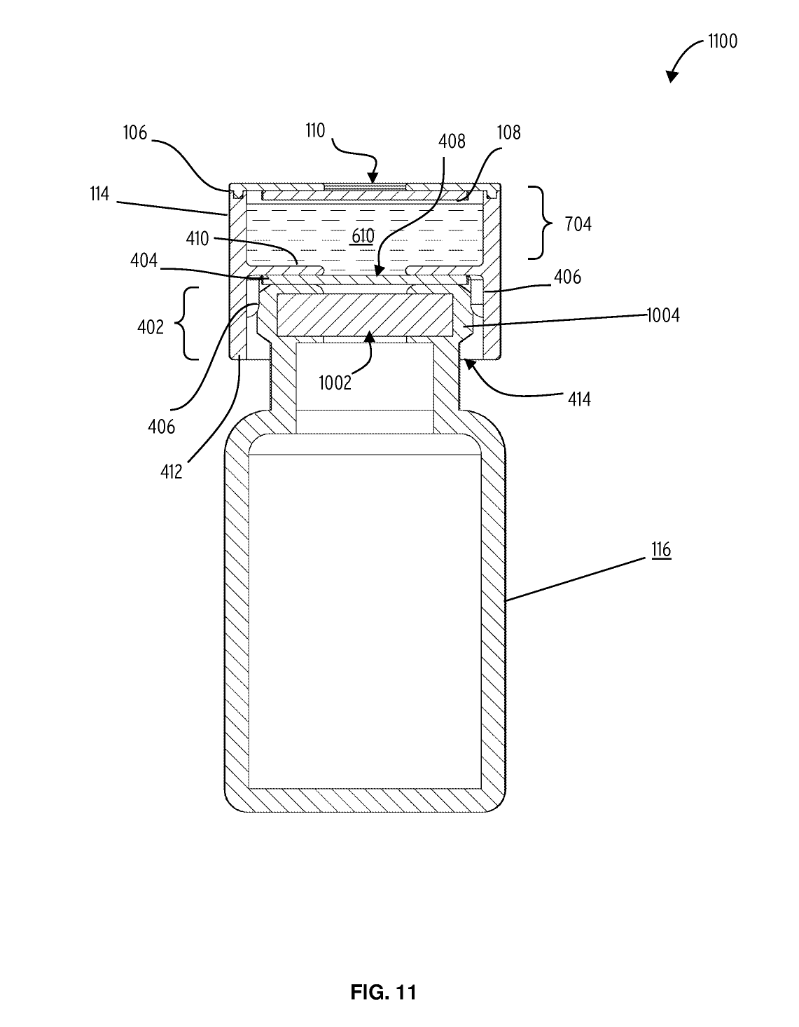

Referencing FIG. 11, the disinfecting cap 1100 being displayed mounted to a multi-dosage injection vial 116. the

The disinfecting cap 1100 comprises a first section 704 and a second section 402. The first section comprises a first seal 108, a first plate 106 comprising a first needle port 110, a lateral wall 114, a sanitizing agent 610, a second plate 410, and a second seal 404. The second section 402 comprises a sleeve mount 412, a plurality of ribs 406, and a shaft opening 414. The multi-dosage injection vial 116 comprises a cap 1004 and a needle port 1002. The cap 1004 being sleeved by the sleeve mount 412 and retained by the plurality of ribs 406. The second seal 404 being retained against the cap 1004 and the second plate 410. The first needle port 110, the sanitizing agent 610, and the second needle port 408 being aligned with the needle port 1002.

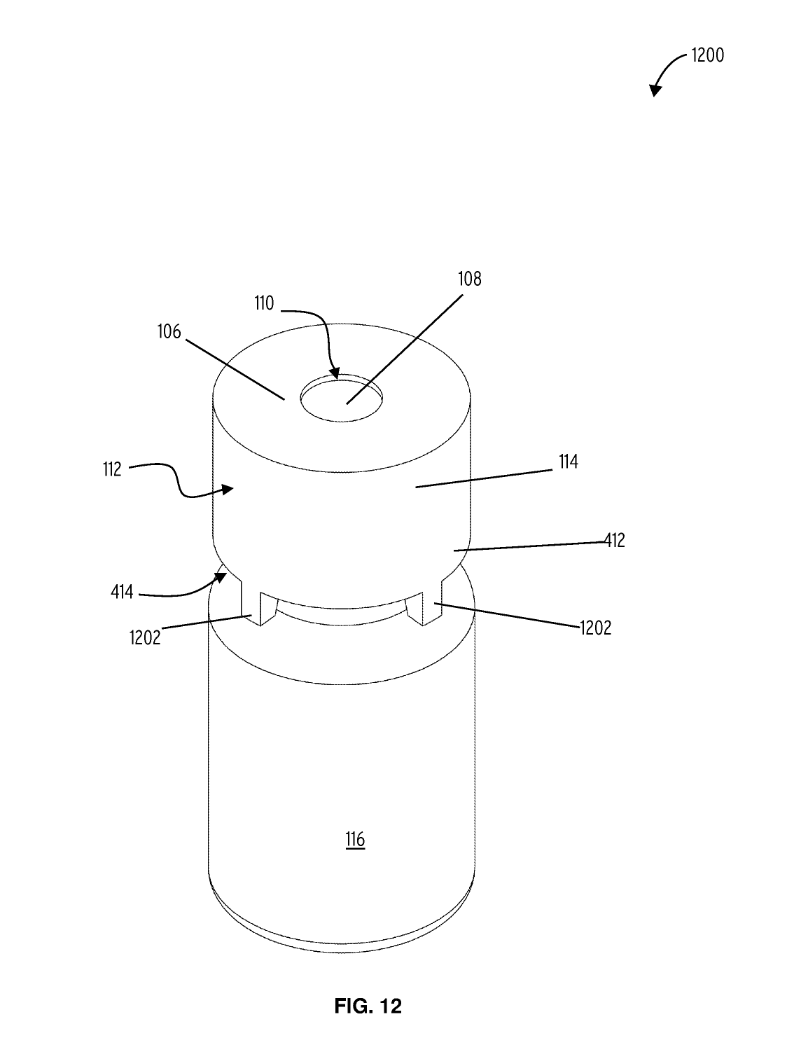

Referencing FIG. 12, the disinfecting cap 1200 comprises a first plate 106, a first seal 108, a first needle port 110, a canister body 112, a lateral wall 114, a sleeve mount 412, a shaft opening 414, and at least one wedge-hook fastener 1202. The at least one wedge-hook fastener 1202 being perimetrically positioned around the shaft opening 414 of the shaft opening 414. The disinfecting cap 1200 being mounted to a multi-dosage injection vial 116 and retained in place through the utilization of the at least one wedge-hook fastener 1202.

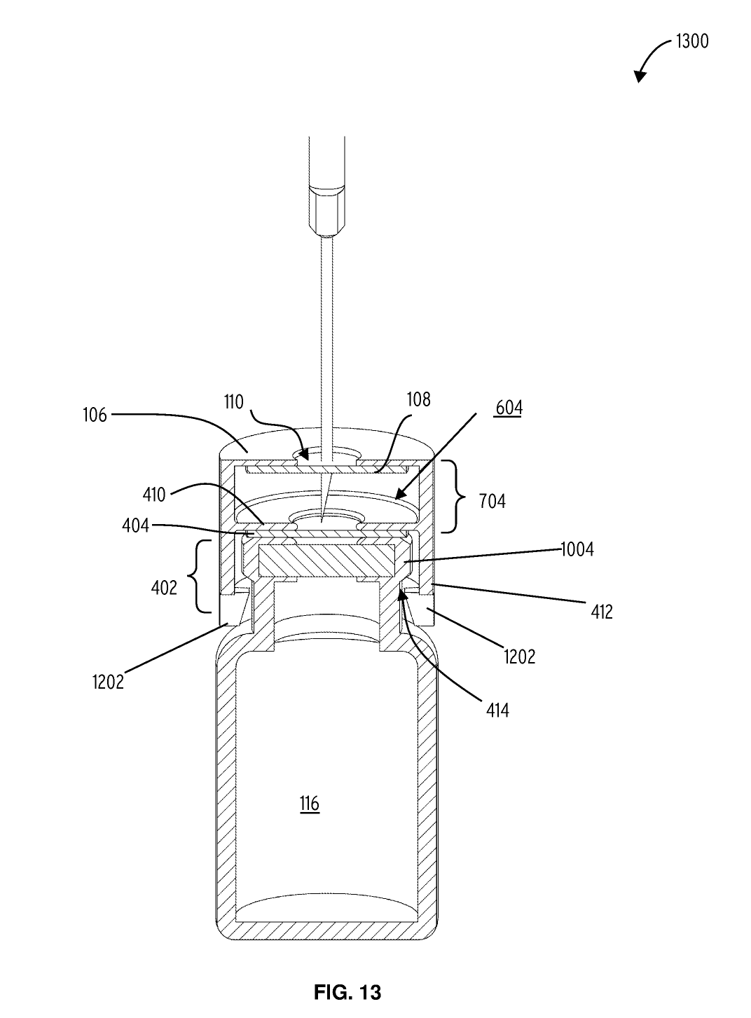

Referencing FIG. 13, the disinfecting cap 1300 comprises a first section 704 and a second section 402. The first section 704 comprises a first plate 106 comprising a first needle port 110, a first seal 108, an inner chamber 604, a second plate 410, and a second seal 404. The second section 402 comprises a sleeve mount 412, a shaft opening 414, and an at least one wedge-hook fastener 1202. The disinfecting cap 1300 mounts to the cap 1004 of a multi-dosage injection vial 116 through the sleeve mount 412. The at least one wedge-hook fastener 1202 engage and securely retain the disinfecting cap 1300 to the cap 1004 after snapping into position.

What is claimed is:

1. A disinfecting cap comprises:
a first section;
a second section;
the first section comprises first plate, a container, a first seal, a second seal, and a sanitizing agent;
the second section comprises a sleeve mount;
the container comprises a second plate, a lateral wall, and an inner chamber;
the first plate and the second plate comprise a first needle port and a second needle port, respectively;
the lateral wall being peripherally positioned around the inner chamber;
the inner chamber and the lateral wall being positioned between the first plate and the second plate;
the second section being adjacent to the second plate and opposite the first plate;
the first needle port and the second needle port being collinearly aligned to the sleeve mount;
the first seal being occusively positioned against the first needle port within the container;
the second seal being occusively positioned against the second needle port within the sleeve mount; and
the sanitizing agent being retained within the inner chamber between the first seal and the second seal.

2. The disinfecting cap of claim 1 comprises:
the second section comprises a plurality of ribs, radially positioned within the sleeve mount adjacent to the second plate.

3. The disinfecting cap of claim 1 comprises:
the second section comprises a shaft opening and at least one wedge-hook fastener;
the shaft opening being positioned opposite the second plate across the sleeve mount; and
the at least one wedge-hook fastener being perimetrically positioned to the shaft opening.

4. The disinfecting cap of claim 1 comprises:
the first plate comprises a ridge peripherally positioned to the first needle port;
the lateral wall comprises a recessed channel peripherally positioned to the inner chamber; and
the recessed channel being coincidentally engaged by the ridge.

5. A method of manufacturing a disinfecting cap comprises:
forming a first plate in a key cap mold comprising an exterior face, an interior face, a first needle port, and a raised ridge peripherally positioned to the first needle port on the interior face;
forming a canister body in a canister base mold comprising an inner chamber, a lateral wall comprising a recessed channel, a second plate comprising a second needle port, and a sleeve mount comprising a plurality of radially positioned ribs;
positioning a second seal occlusively over the second needle port opposite the inner chamber;
positioning a first seal occlusively over the first needle port on the interior face;
filling the inner chamber with a sanitizing agent;
mounting the raised ridge to the recessed channel; and
hermetically sealing the sanitizing agent in the inner chamber by joining the first plate to the canister body.

6. The method of claim 5, comprises:
forming the first plate and the canister body from an extruded thermoplastic resin.

7. The method of claim 6, wherein the extruded thermoplastic resin comprises acrylonitrile butadiene styrene (ABS) plastic resin.

8. The method of claim 5, wherein the first seal and the second seal comprise butyl rubber.

9. The method of claim 5, wherein hermetically sealing the sanitizing agent in the inner chamber by joining the first plate to the canister body comprises ultrasonically welding the first plate to the canister body.
